(19) United States
(12) Patent Application Publication
(10) Pub. No.: US 2005/0060655 A1
(43) Pub. Date: Mar. 17, 2005

(54) Distance-learning system with dynamically constructed menu that includes embedded applications

(75) Inventors: Scott Gray, Urbana, IL (US); Patrick Flanigan, Champaign, IL (US); Kendell Welch, Champaign, IL (US)

Correspondence Address: BANNER & WITCOFF, LTD., TEN SOUTH WACKER DRIVE, SUITE 3000, CHICAGO, IL, 60606, US

(73) Assignee: UserActive, Champaign, IL (US)

(21) Appl. No.: 10/660,994

(22) Filed: Sep. 12, 2003

(51) Int. Cl. G06F 3/00

(52) U.S. Cl. 715/745; 715/747; 715/744

(57) ABSTRACT

A distance-learning system includes a toolbar, which may be docked within a Web browser, that has a dynamically constructed menu system and facilitates providing, to distance-learning students, multiple technologies and/or integration of distance-learning activities with Web-based content. To dynamically construct the toolbar's menu structure, the toolbar may obtain profile information from one or more remotely located server computers. The profile information may be specific to an institution and/or an individual user. Menu items within the toolbar may include the following types of items: a hyperlink that, when activated, navigates a Web-pane pane of the browser; a terminal-server client to a remote machine or application; a Unix-shell client; an embedded browser; a local application; and an instance of a docked info bar. Within a Web browser's display, content for distance learning may be displayed in a Web-page pane while a student is performing distance-learning tasks in an embedded-application pane.

### CROSS-REFERENCE TO RELATED APPLICATIONS

This application is related to application Ser. No. ______, attorney docket number 6030.00004, entitled Capturing and Processing User Actions on a Computer System for Recording and Playback, which is incorporated herein by reference and which was filed concurrently with this application.

### TECHNICAL FIELD

The invention relates generally to distance learning. More particularly, the invention relates to a distance-learning system with a dynamically constructed menu structure that includes embedded applications.

### BACKGROUND OF THE INVENTION

In online learning courses of technology, science, and other subjects, access by the student to the technology being taught is typically advantageous so that students can gain experience and learn while using the technology being taught, such as a computer software application program. Conventionally, providing access to technologies of this type for distance learning has been difficult. Typically, students need administrative access on computer systems, and the students need to use applications that are difficult to access for a student who is inexperienced with the technology. This situation is often exacerbated when the distance-learning students are online students many miles away from their instructors.

Accordingly, a distance-learning system that facilitates providing, to students, access to various types of technology in a user-friendly and flexible way would be desirable.

### SUMMARY OF THE INVENTION

A distance-learning system in accordance with embodiments of the invention may be a client-server application that enables and delivers technologies via a terminal portal for distance learning and for enabling exchanging files on the server side to allow instructors and students to easily exchange files, such as for grading, help, review, and the like.

A distance-learning system in accordance with embodiments of the invention may provide content from the World Wide Web and may provide terminal services for other applications to bring together resources pertinent to distance-learning activities.

In accordance with embodiments of the invention, a toolbar, which may be docked within a Web-browser display, having a dynamically constructed menu system provides flexibility that facilitates providing, to distance-learning students, multiple technologies and/or integration of distance-learning activities with Web-based content. A toolbar of this type is advantageous because it gives students an easily accessed menu system that is part of Web browser, which is currently a widely used software program. The dynamic menu system provides flexibility and facilitates modifying the set of resources that are available to a student or group of students.

The toolbar may include a dynamically constructed menu. To dynamically construct such a menu, the toolbar may obtain profile information from one or more remotely located server computers, such as a menu profile server. The profile information, may be contained in an XML file, or may be transferred to the toolbar in any other suitable format.

Based on the profile information, menu items, such a pop-up menu items, may be dynamically included in the menu structure of the toolbar. The profile information may be specific to an institution, such as a business organization or a university, and/or the profile information may be specific to an individual user.

A distance learning system, in accordance with embodiments of the invention, may be used for bringing together various types of resources including Web pages, entire applications, and delivery of terminal sessions. Menu items within the toolbar may include the following types of items: a hyperlink that, when activated, navigates a main browser window; a terminal-server client to a remote machine or application; a Unix-shell client; an embedded browser; a local application; and an instance of a docked info bar.

A toolbar, in accordance with embodiments of the invention, may be used for delivering terminal services. For instance, the toolbar may connect to a server, such as a Windows® application server, for delivering an application, such as a Windows® desktop and/or a Windows® application program, in an embedded-application pane of a Web browser's display. Various embedded applications, such as enterprise applications, Windows® applications and/or Windows® desktop, Unix applications (e.g., a third-party open-source Unix shell), and a Web browser, may be delivered through the toolbar and the embedded-application pane.

Content for distance learning may be displayed in the Web-page pane while a student is performing distance-learning tasks in the embedded-application pane.

An event engine for recording and playing back a user's interaction with menu items within a software program may have its user interface displayed on the toolbar. The event engine when used within the distance-learning system's toolbar may be used for recording and playing user events inside of an embedded terminal-server client and/or other embedded applications.

When a terminal-service client is active in the embedded-application pane, and a Web page is being displayed in the Web-page pane, instead of showing instructional screen shots in the Web-page pane, a pre-recorded event-engine file can be played by the embedded terminal-server client. So, instead of showing screen shots as a student scrolls down through content in the Web-page pane, the pre-recorded event-engine file may be played thereby causing menus to cascade and the like. This is advantageous for learning how to accomplish tasks in applications such as Microsoft® Word and Excel, and in various versions of the Windows® Operating System, for example. Accordingly, clicking on links in a Web page in the Web-page pane may cause playback of events that were previously recorded by the event engine and that show, in the embedded application pane, how to perform a particular task, such as navigating an application program's menu structure.

Additional features and advantages of the invention will be apparent upon reviewing the following detailed description.

### BRIEF DESCRIPTION OF THE DRAWINGS

FIG. 1 is a schematic diagram of portions of a Web-browser user interface in accordance with embodiments of the invention.

FIG. 2 is a schematic block diagram of a distance-learning system in accordance with embodiments of the invention.

FIG. 3 is a state diagram for a toolbar in accordance with embodiments of the invention.

FIG. 4 is a screen shot of a Web-browser display with a toolbar in the disconnected state in accordance with embodiments of the invention.

FIG. 5 is a screen shot of a Web-browser display with a toolbar in the connected state in accordance with embodiments of the invention.

FIG. 6 is a screen shot of a Web-browser display with a toolbar in the logged-on-inactive state in accordance with embodiments of the invention.

FIG. 7 is a screen shot of a Web-browser display with a toolbar in the logged-on-active state in accordance with embodiments of the invention.

FIG. 8 is a schematic diagram showing a general class layout for a toolbar in accordance with embodiments of the invention.

### DETAILED DESCRIPTION OF THE INVENTION

I. Terminology

In the following description of various embodiments of the invention, reference is made to the accompanying drawings in which embodiments of the invention are shown by way of illustration. Other embodiments may be utilized and structural and functional modifications may be made without departing from the scope of the invention.

Definitions for the following terms are included to facilitate an understanding of the detailed description.
ActiveX®—a set of technologies that enables software components to interact with one another in a networked environment, regardless of the language in which the components were created. ActiveX, which was developed as a proposed standard by Microsoft® in the mid 1990s and is currently administered by the Open Group, is built on Microsoft's Component Object Model (COM). Currently, ActiveX is used primarily to develop interactive content for the World Wide Web, although it can be used in desktop applications and other programs. ActiveX controls can be embedded in Web pages to produce animation and other multimedia effects, interactive objects, and sophisticated applications.
ActiveX controls—reusable software components that incorporate ActiveX technology. These components can be used to add specialized functionality, such as animation or pop-up menus, to Web pages, desktop applications, and software development tools. ActiveX controls can be written in a variety of programming languages, including C, C++, Visual Basic, and Java.
Client/server architecture—an arrangement used on local area networks that makes use of distributed intelligence to treat both the server and the individual workstations as intelligent, programmable devices, thus exploiting the full computing power of each. This is done by splitting the processing of an application between two distinct components: a “front-end” client and a “back-end” server. The client component is typically a complete, stand-alone personal computer (although other types of computing devices may also be considered clients), and the client component typically offers the user its full range of power and features for running applications. The server component is a computer, such as a personal computer, a minicomputer, or a mainframe, that typically provides the traditional strengths offered by minicomputers and mainframes in a time-sharing environment: data management, information sharing between clients, and/or network administration and security features. The client and server machines typically work together to accomplish the processing of an application being used. Not only does this increase the processing power available over older architectures but it also uses that power more efficiently. The client portion of the application is typically optimized for user interaction, whereas the server portion provides the centralized, multi-user functionality.
Component Object Model (COM)—a specification developed by Microsoft® for building software components that can be assembled into programs or add functionality to existing programs running on Microsoft® Windows® platforms. COM components can be written in a variety of languages, although most are written in C++, and can be unplugged from a program at run time without having to recompile the program. COM is the foundation of the OLE (object linking and embedding), ActiveX, and DirectX specifications.
Daemon—a program associated with UNIX systems that performs a housekeeping or maintenance utility function without being called by the user. A daemon sits in the background and is activated only when needed, for example, to correct an error from which another program cannot recover.
Desktop—an on-screen work area that uses icons and menus to simulate the top of a desk. A desktop is characteristic of the Apple Macintosh and of windowing programs such as Microsoft® Windows®. Its intent is to make a computer easier to use by enabling users to move pictures of objects and to start and stop tasks in much the same way as they would if they were working on a physical desktop.
Distance learning—an educational or learning process or system in which the teacher/instructor is separated geographically or in time from his or her students, or in which students are separated from other students or educational resources. Distance learning may be effected through the implementation of computer and electronic technology to connect teacher and student in either real or delayed time or on an as-needed basis. Content deliver may be achieved through a variety of technologies, including satellites, computer, cable television, interactive videio, electronic transmissions via telephone lines, the World Wide Web and other Internet technology, and others. Distance learning does not preclude traditional learning processes; it may be used in conjunction with in-person classroom or professional training procedures and practices.
Dynamic Link Library (DLL)—a library of executable functions or data that can be used by a Windows® application. Typically, a DLL provides one or more particular functions and a program accesses the functions by creating either a static or dynamic link to the DLL. A static link remains constant during program execution while a dynamic link is created by the program as needed. DLLs may also contain just data.
Extensible Markup Language (XML)—used to create new markups that provide a file format and data structure for representing data on the web. XML allows developers to describe and deliver rich, structured data in a consistent way.
Hyperlink (also referred to as “link”)—a connection between an element in a hypertext document, such as a word, phrase, symbol, or image, and a different element in the document, another hypertext document, a file, or a script. The user activates the link by clicking on the linked element, which is usually underlined or in a color different from the rest of the document to indicate that the element is linked. Hyperlinks are indicated in a hypertext document through tags in markup languages such as SGML and HTML. These tags are generally not visible to the user.
Peer-to-peer architecture—a network of two or more computers that use a similar program or type of program to communicate and share data. Each computer, or peer, is considered equal in terms of responsibilities and each acts as a server to the others in the network. Unlike a client/server architecture, a dedicated file server is not required. However, network performance is generally not as good as under client/server, especially under heavy loads.
Registry—A central hierarchical database in various versions of the Windows Operating System used to store information used for configuring a system for one or more users, applications, and hardware devices. The Registry contains information that Windows frequently references during operation, such as profiles for users, the applications installed on the computer and the types of documents each can create, property sheet settings for folders and application icons, what hardware exists on the system, and which ports are being used. The Registry replaces most of the text-based .ini files used in Windows 3.x and MS-DOS configuration files, such as AUTOEXEC.BAT and CONFIG.SYS.
Toolbar—In an application in a graphical user interface, a set of user-interface (“UI”) elements, such as a row, column, or block of on-screen buttons or icons. When these UI elements are clicked on with the mouse, macros or certain functions of the application are activated. For example, word processors often feature toolbars with buttons for changing text to italic, boldface, and other styles. Toolbars often can be customized by the user and usually can be moved around on the screen according to the user's preference. Like a menu bar, a toolbar may provide pop-up, or drop-down, menus from which menus can be selected by a user. Names of available menus are displayed in the toolbar; choosing one with the keyboard or mouse causes the list of options in that menu to be displayed.
Acronym for Uniform Resource Locator. An address for a resource on the Internet. Web browsers use URLs to locate Internet resources. A URL specifies the protocol to be used in accessing the resource (such as http: for a World Wide Web page or ftp: for an FTP site), the name of the server on which the resource resides (such as //www.whitehouse.gov), and, optionally, the path to a resource (such as an HTML document or a file on that server).
Web browser (also referred to as “browser”)—a client application that enables a user to view HTML documents on the World Wide Web, another network, or the user's computer; follow the hyperlinks among them; and transfer files. Text-based Web browsers, such as Lynx, can serve users with shell accounts but show only the text elements of an HTML document; most Web browsers, however, require a connection that can handle IP packets but will also display graphics that are in the document, play audio and video files, and execute small programs, such as Java applets or ActiveX controls, that can be embedded in HTML documents. Some Web browsers require helper applications or plug-ins to accomplish one or more of these tasks. In addition, most current Web browsers permit users to send and receive e-mail and to read and respond to newsgroups.
   II. Introduction to the Distance-Learning System and the Toolbar

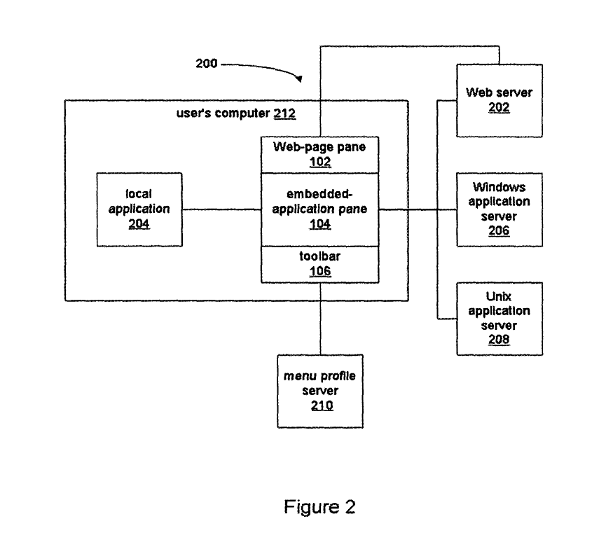

Referring to FIG. 2, a distance learning system 200 may be thought of as a client-server application. One or more server computers, such as Web server 202, Windows® application server 206, and Unix application server 208 host application programs for which respective client portions of the hosted programs may be embedded within a display on a user's computer 212. As will be apparent, principles of the invention are not limited to use within client/server architectures. The principles of the invention may also be applied in peer-to-peer architectures, for instance. The distance-learning system 200 allows a user to access remotely hosted computing resources, such as various Windows® applications and/or a Unix shell, through a Web browser or through other software resident on the user's computer 212.

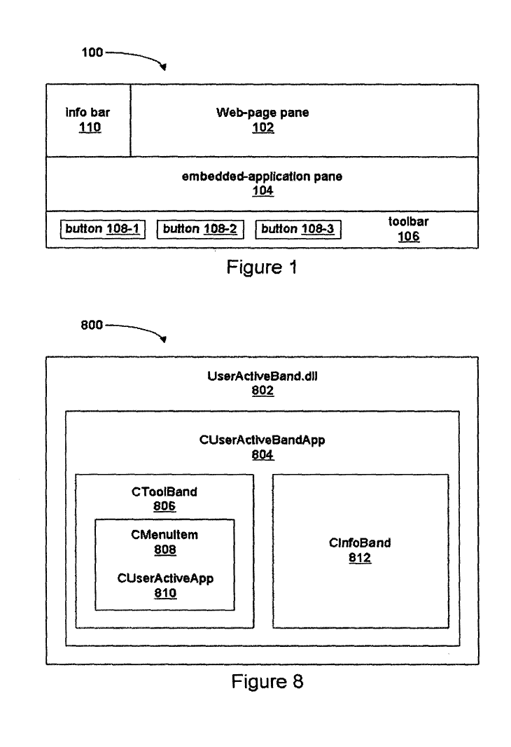

Referring to FIGS. 1 and 2, the user's computer 212 may include a toolbar 106 that docks inside a browser window 100 or that is embedded within the display of other types of software, such as a Windows® Desktop and/or an application program, such as Microsoft® Word, and the like.

A toolbar 106 may include buttons, such as buttons 108-1 through 108-3 and may enable various types of mechanisms for delivering information and/or applications used for distance learning of information technology, science, and other subjects. The toolbar 106 may be docked (i.e., located in a fixed position), such as at the bottom, within a software program's display area. For instance, toolbar 106 is shown docked at the bottom of the Web browser window 100.

The toolbar 106 may include a dynamically constructed menu. To dynamically construct such a menu, the toolbar 106 may obtain profile information from one or more remotely located server computers, such as menu profile server 210. The profile information, which is discussed in more detail below, may be contained in an XML file, or may be transferred to the toolbar in any other suitable format.

Based on the profile information received from the menu profile server 210, menu items, such a pop-up menu items, may be dynamically included in the menu structure of the toolbar 106. The profile information received from the menu profile server 210, may be specific to an institution, such as a business organization or a university, and/or the profile information may be specific to an individual user.

A distance learning system 200 may be used for bringing together various types of resources including Web pages, entire applications, and delivery of terminal sessions. Menu items within the toolbar 106 may include the following types of items: a hyperlink that, when activated, navigates Web-page pane 102; a terminal-server client to a remote machine or application; a Unix-shell client; an embedded browser; a local application 204; and an instance of a docked info bar.

III. Dynamic Construction of the Toolbar

The way that the toolbar's menu structure is dynamically constructed when a user initiates a distance-learning session allows the toolbar's menu structure and functionality to be configured based on user privileges and/or preferences, which may be stored on a remote server, such as menu profile server 210.

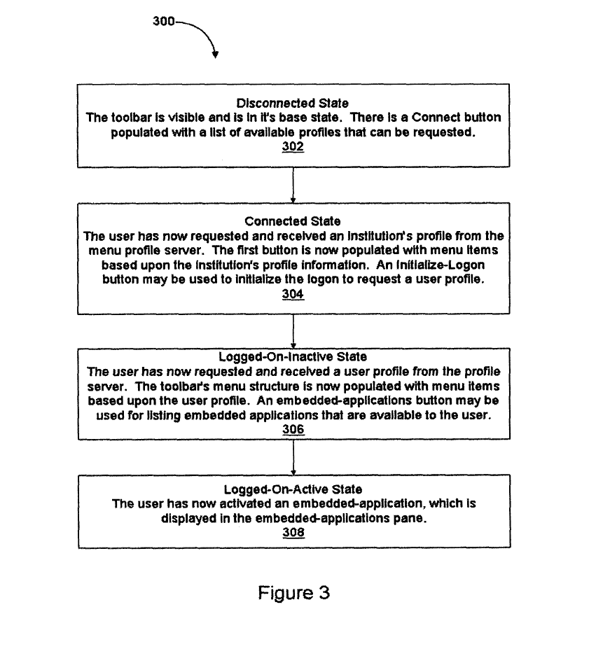

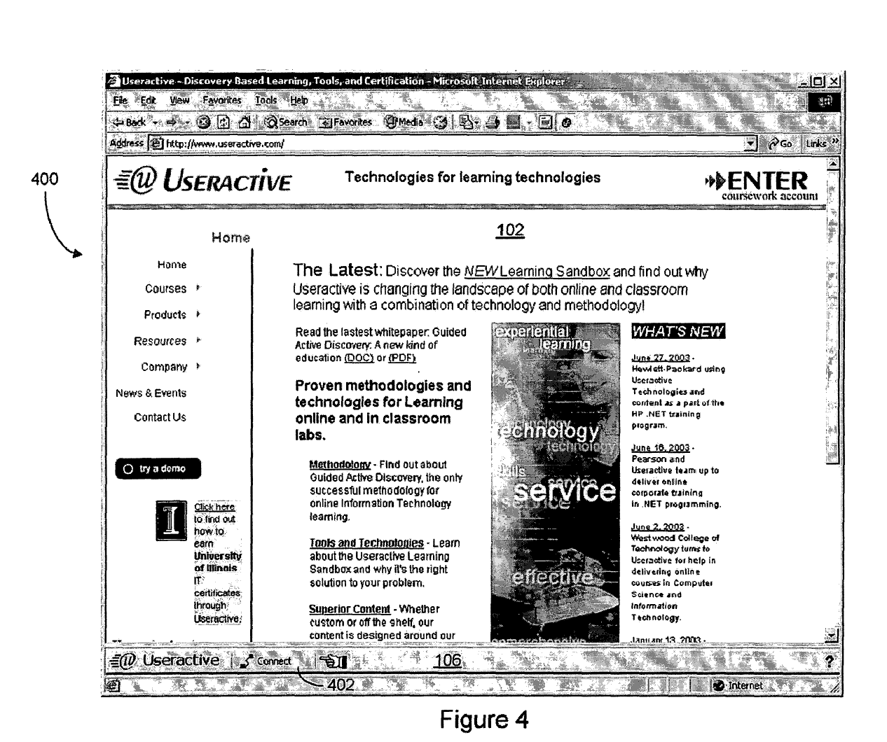

FIG. 3 depicts a state diagram 300 showing toolbar states as a user initiates a distance-learning session. FIG. 4 depicts a screenshot of a Web browser display 400 including a toolbar 106 that is in the disconnected state 302. In such a state, the toolbar 106 is visible and is in it's base state. There is a Connect button 402, which may be populated with a list of available institution profiles (not shown) that a user can request.

An example institution profile is listed below:

```
<USERACTIVEPROFILE LOGO=“Ersatz” ICON=“ersatz.ico”
CHECKTUNNEL=“TRUE” CHANGEPASSWORD=“TRUE”
FONT=“Tahoma”>
<TITLE VALUE=“Ersatz” FONT=“Arial Black”>
    <ACTION TYPE=‘browser’
                    URL=‘http://www.useractive.com/’>
    </ACTION>
</TITLE>
<POPUP NAME=‘Services’>
<SEARCH NAME=‘PeopleSoft.com’
URL=‘http://www.peoplesoft.com/psp/search/CUSTOMER/CUST/
c/TAP_SRCH_MENU_A.TAP_SRCH_COMPONENT.GBL?siteCD=
corp%26languageCD=ENG%26SearchStr=’
    AUTHENTICATE=‘FALSE’>
</SEARCH>
<SEARCH NAME=‘Google.com’
    URL=‘http://www.google.com/search?sourceid=navclient%26ie=UTF-
8%26oe=UTF-8%26q=’
    AUTHENTICATE=‘FALSE’>
</SEARCH>
<LINK NAME=‘Peoplesoft Req.’
    URL=‘http://www.useractive.com/˜kwelch/pplsoft-req.gif’
    AUTHENTICATE=‘FALSE’>
</LINK>
<LINK NAME=‘Peoplesoft Docs’
    URL=‘http://www.useractive.com/˜kwelch/pplsoft-foot.gif’
    AUTHENTICATE=‘FALSE’>
</LINK>
<LINK NAME=‘Peoplesoft.com’
    URL=‘http://www.peoplesoft.com/’
    AUTHENTICATE=‘FALSE’>
</LINK>
</POPUP>
<SHELL NAME=‘Tunnel’
    AUTHENTICATE=‘TRUE’
    PROTOCOL=‘3’
    TUNNELING=‘TRUE’
    VISIBLE=‘TRUE’
    URL=‘cold.useractive.com’
    PORT=‘22’
    PORTFORWARD=‘L127.0.0.2:3391 63.171.219.80:3389’
    DOMAIN=‘’
    WINNAME=‘Tunnel’
    TABTEXT=‘Tunnel’>
</SHELL>
</USERACTIVEPROFILE>
```

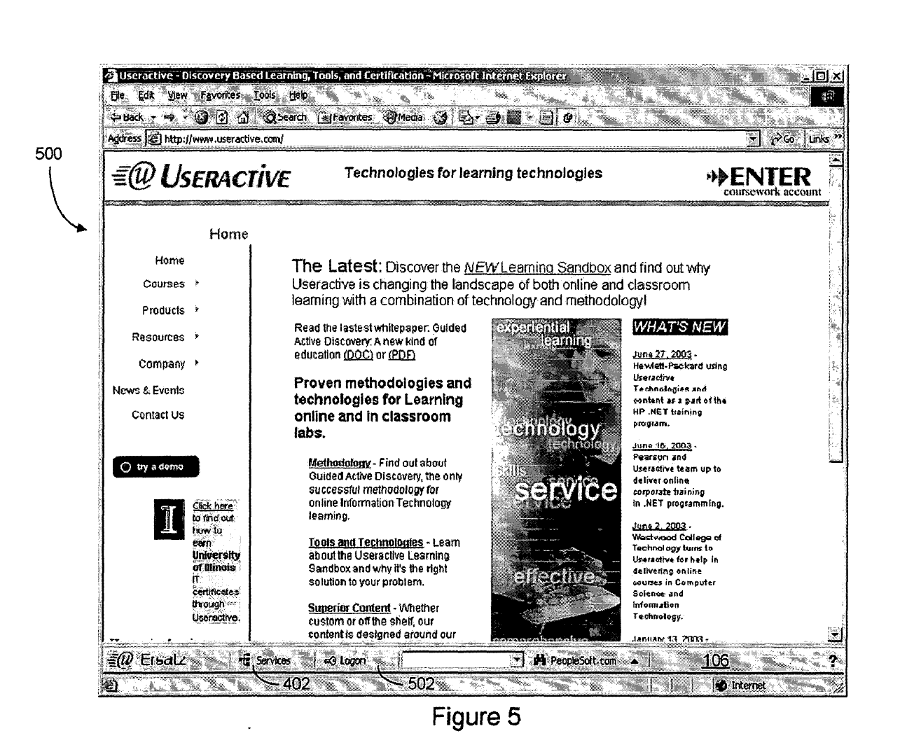

FIG. 5 depicts a screenshot of a Web browser display 500 including a toolbar 106 that is in the connected state 304. In such a state, the user has requested (e.g., by clicking on the connect button) and received an institution's profile from the menu profile server 210, which may have a daemon running on it for servicing requests for profile information. The Connect button 402 is now populated with menu items (not shown) based upon the institution's profile information. An Initialize-Logon button 502 may be used to initialize a logon to request a user profile from the menu profile server 210.

An example user profile is listed below:

```
<USERACTIVEPROFILE LABHANDLE=‘scootsman’ DEBUGMODE=
‘FALSE’ STOPPER=‘FALSE’>
<POPUP NAME=‘Student’>
<INFOBAR NAME=‘Lessons, Quizzes, and Objectives’
    URL=‘http://www.useractive.com/infobar3/’
    AUTHENTICATE=‘TRUE’>
</INFOBAR>
<INFOBAR NAME=‘File Transfer’
    URL=‘http://www.useractive.com/infobar/files.html’
    AUTHENTICATE=‘TRUE’>
</INFOBAR>
</POPUP>
<POPUP NAME=‘Tools’>
<TSAC NAME=‘Internet Explorer’
    AUTHENTICATE=‘TRUE’
    URL=‘63.171.219.80’
    URL2=‘127.0.0.2’
    PORT=‘3389’
    PORT2=‘3391’
    DOMAIN=‘WIN’
    EXENAME=‘C:\Program Files\Internet Explorer\IEXPLORE.EXE’
    WINNAME=‘MSIE’
    TABTEXT=‘MSIE’>
</TSAC>
<TSAC NAME=‘Visual Studio .NET’
    AUTHENTICATE=‘TRUE’
    STARTMAX=‘TRUE’
    URL=‘63.171.219.80’
    URL2=‘127.0.0.2’
    PORT=‘3389’
    PORT2=‘3391’
    DOMAIN=‘WIN’
    EXENAME=‘C:\Program Files\Microsoft Visual Studio
.NET\Common7\IDE\devenv.exe’
    WINNAME=‘VS.NET’
    TABTEXT=‘VS.NET’>
</TSAC>
<TSAC NAME=‘Windows Desktop’
    AUTHENTICATE=‘TRUE’
    URL=‘63.171.219.80’
    URL2=‘127.0.0.2’
    PORT=‘3389’
    PORT2=‘3391’
    DOMAIN=‘WIN’
    EXENAME=‘’
    WINNAME=‘Desktop’
    TABTEXT=‘Desktop’>
</TSAC>
</POPUP>
</USERACTIVEPROFILE>
```

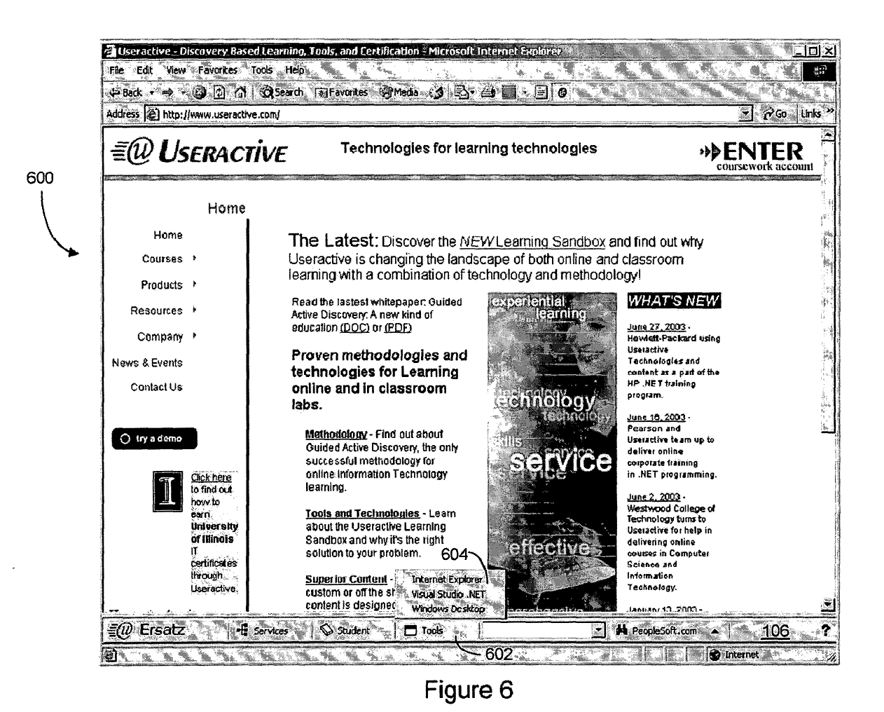

FIG. 6 depicts a screenshot of a Web browser display 600 including a toolbar 106 that is in the logged-on-inactive state 306. In such a state, the user has now requested and received a user profile from the menu profile server 210. The toolbar's menu structure is now populated with menu items based upon the user profile. An embedded-applications button 602 may be used for listing embedded applications that are available to the user. For instance, in FIG. 6, menu items labeled Internet Explorer, Visual Studio NET, and Windows® Desktop are shown in pop-up menu 604.

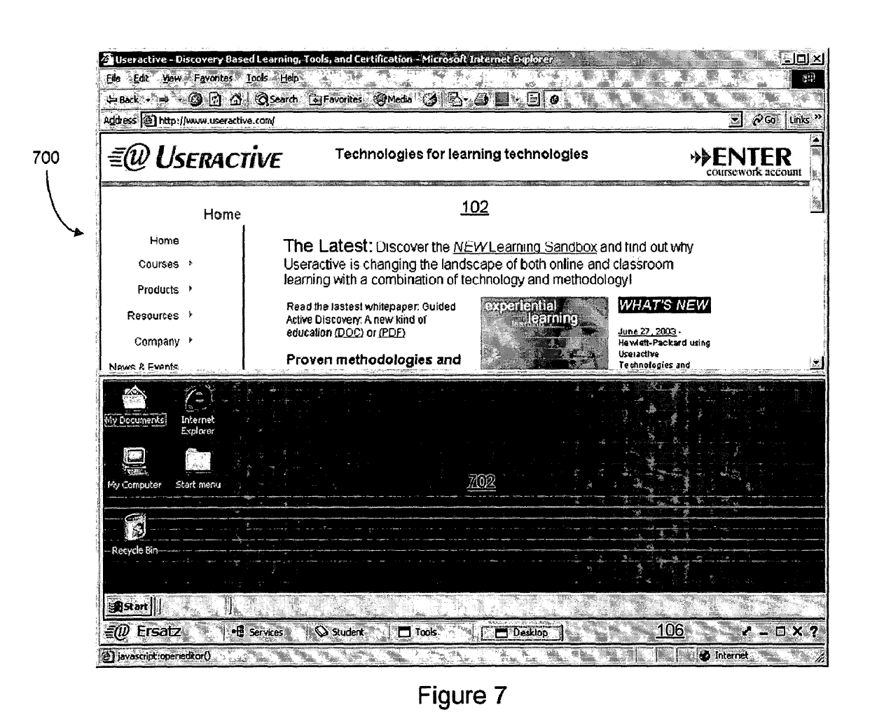

FIG. 7 depicts a screenshot of a Web browser display 700 including a toolbar 106 that is in the logged-on-active state 308. In such a state, the user has now activated an embedded-application, which is displayed in the embedded-application pane 104. The user may then interact with the displayed embedded application 702 in the embedded-application pane 104 (FIG. 1).

IV. Applications Embedded Within the Toolbar

A toolbar 106, in accordance with embodiments of the invention, may be used for delivering terminal services. For instance, as discussed above, the toolbar may connect to a server, such as Windows® application server 206, for delivering an application, such as a Windows® desktop and/or a Windows® application program, in the embedded-application pane 104. There could be one or more servers involved depending on which application is being delivered. Various embedded applications, such as enterprise applications, Windows® applications and/or Windows® desktop, Unix applications (e.g., a third-party open-source Unix shell), and a Web browser, may be delivered through the toolbar 106 and the embedded-application pane 104.

Various software programs, such as Internet Explorer and Microsoft Word, use a system called COM, more specifically ActiveX, that allows developers to create a toolbar within the software programs. Such a toolbar may be created by implementing specific interfaces and by entering pertinent information into the registry.

Embodiments of the invention use embedded applications that are ActiveX COM objects. Alternative embodiments of the invention may be implemented with other types of technology, such as Java.

The relationship of the embedded applications to the toolbar is similar to the toolbar's relationship to the software that the toolbar is embedded within, such as Internet Explorer. For instance, the toolbar 106 is hosting the embedded applications within the toolbar 106. The embedded applications are ActiveX COM objects, and the toolbar is a COM object that's inside a host software module, such as Internet Explorer, which is an ActiveX COM object.

FIG. 8 depicts a schematic diagram of a general class layout 800 for an implementation of a toolbar 106 in accordance with embodiments of the invention. CUserActiveBandApp 804 is a topmost ActiveX control and is inside the UserActiveBand.dll 802 COM DLL. CToolBand 806 and CInfoBand 812 are exposed COM objects both of which implement IDeskBand. CInfoBand 812 supports the IWebBrowswer2 interface. Toolbar menu items may be various types of embedded ActiveX controls, such as an embedded Microsoft Internet Explorer browser control; an embedded Microsoft Terminal Services Advanced Client control; or an embedded Shell control based upon open source PuTTY (an open-source Unix shell). CMenuItem 808 and CUserActiveApp 810 are C++ classes that implement instances of generic menu items and associated embedded application controls.

Embedded applications may be embedded within the toolbar 106 as generic menu items having various parameters, such as an IP address of one or more servers hosting the embedded application, login information such as a username and password, what client software the embedded application uses, and other pertinent information. When a user activates a menu item for an embedded application, a message, with the menu item's parameters, is sent to the toolbar so that the user's activation of the menu item may be processed. For instance, when a user clicks a menu item for creating an embedded Unix shell, a message is sent to the toolbar with information for that menu item, which results in an embedded application pane 104 being created and having a Unix-shell ActiveX control within the embedded-application pane. In this case, the menu item that is fired upon acts on a specific instance of CUserActiveApp 810, which creates an embedded window that hosts an ActiveX control. This UNIX shell application control wraps PuTTY, an open source UNIX shell implementation. This COM wrapper class exposes interactive methods and events. Login information may also be sent to the Unix application server 208.

Rather than being hosted by a remote server, an embedded application may be a local application 204 that is run locally on a user's computer 212. For instance, to connect to certain remotely located applications, a software client, such as Microsoft SQL Shell may be accessed locally, as a local application 204, on the user's computer 212.

V. Concurrent Operations in the Web-Page Pane and the Embedded-Application Pane

Content for distance learning may be displayed in the Web-page pane 102 while a student is performing distance-learning tasks in the embedded-application pane 104.

The info bar 110 may be used for handing in homework, grading, file transfer, and the like. The info bar 110 docks on the left side of the browser display 100 while the toolbar 106 docks at the bottom. They interact with one another through COM interfaces. The inforbar 110 and the toolbar 106 are separate due to differences in functionality. The role of the info bar 110 is to provide Web-based course management information, while the toolbar 106 provides a much wider range of capabilities.

An event engine for recording and playing back a user's interaction with menu items within a software program is described in co-pending application Ser. No. ______, attorney docket number 6030.00004, entitled Capturing and Processing User Actions on a Computer System for Recording and Playback, which is incorporated herein by reference and which was filed concurrently with this application. Such an event engine may be an ActiveX control and may have its user interface displayed on the toolbar 106. The event engine when used within the distance-learning system's toolbar 106 may be used for recording and playing user events that would show up inside of an embedded terminal-server client and/or other embedded applications.

When a terminal-service client is active in the embedded-application pane 104, and a Web page is being displayed in the Web-page pane 102, instead of showing instructional screen shots in the Web-page pane 102, a pre-recorded event-engine file can be played by the embedded terminal-server client. So, instead of showing screen shots as a student scrolls down through content in the Web-page pane 102, the pre-recorded event-engine file may be played thereby causing menus to cascade and the like. This is advantageous for learning how to accomplish tasks in applications such as Microsoft® Word and Excel, and in the Windows® Operating System, for example. Accordingly, clicking on links in a Web page in the Web-page pane 102 may cause playback of events that were previously recorded by the event engine and that show, in the embedded application pane 104, how to perform a particular task, such as navigating an application program's menu structure. The two panes interact via a COM interface, IUserActiveTools, which is implemented by the toolbar 106. Interface methods are called programmatically causing events to be fired within the toolbar.

The event engine may also be used in other ways for documentation and/or testing. For instance, a student could record steps that they would take in using an application, and send that file to the instructor. Then the instructor could watch asynchronously what the student did when the student was using the application. This is advantageous in situations in which instructors want test takers to “show their work” so that the instructor can the see the order in which the test-taker performed certain operations, as opposed to merely the end result achieved by the steps performed by the test-taker. In this way an instructor, can examine a recorded event-engine file and determine whether the test-taker performed particular operations and the order in which the test-taker performed those operations.

What has been described above is merely illustrative of the application of the principles of the invention. Those skilled in the art can implement other arrangements and methods without departing from the spirit and scope of the invention. Any of the methods of the invention can be implemented in software that can be stored on computer disks or other computer-readable media.

1. One or more computer-readable media containing computer-executable instructions for facilitating distance learning by performing the steps of:
dynamically constructing a toolbar's menu structure based on profile information retrieved from at least one menu profile server computer, wherein the menu structure includes at least one menu item that, when activated, launches at least one embedded application that is hosted on at least one remote server computer; and
displaying a client portion of the at least one embedded application within an embedded-application pane on a display of a user's computer.

2. The computer-readable media of claim 1 wherein the profile information is specific to at least one of an institution and an individual.

3. The computer-readable media of claim 1 wherein the profile information specifies at least one URL identifying the at least one remote server computer.

4. The computer-readable media of claim 3 wherein the at least one remote server is at least one of a Web server, a Window application server, and a Unix application server.

5. The computer-readable media of claim 1 wherein the at least one menu item is selected from the group consisting of a terminal server client to a remote machine or application; a Unix shell client; an embedded browser; a local application; and an instance of a docked info bar.

6. The computer-readable media of claim 1 wherein the toolbar and the embedded-application pane are displayed within a Web browser's display.

7. The computer-readable media of claim 6 wherein the toolbar is displayed docked within the Web browser's display.

8. The computer-readable media of claim 6 wherein the at least one menu item is selected from the group consisting of: a hyperlink that, when activated, navigates a Web-page pane of the Web browser's display; a terminal server client to a remote machine or application; a Unix shell client; an embedded browser; a local application; and an instance of a docked info bar.

9. The computer-readable media of claim 6 wherein a user's interaction with Web content within a Web-page pane of the browser's display causes playback by an event engine of pre-recorded interaction with at least one application displayed in the embedded-application pane.

10. The computer-readable media of claim 1 wherein the at least one embedded application is an ActiveX COM object embedded within the toolbar.

11. The computer-readable media of claim 10 wherein the toolbar is an ActiveX COM object embedded within a browser displayed by the user's computer.

12. The computer-readable media of claim 1 wherein the toolbar and the embedded-application pane are displayed within a user's desktop.

13. The computer-readable media of claim 1 wherein the toolbar and the embedded-application pane are displayed within a display area of a Windows application running on the user's computer.

14. A user interface for a distance-learning system, the user interface comprising:
a Web-browser display;
a Web-page pane within the Web-browser display that displays a Web page;
a docked toolbar within the Web browser display, wherein the toolbar is populated with menu items based on profile information received from a remote server computer; and
an embedded-application pane that displays, within the Web-browser display, at least one application, which is activated from the docked toolbar.

15. The user interface of claim 14 wherein the profile information is specific to at least one of an institution and an individual.

16. The user interface of claim 15 wherein the menu items are selected from the group consisting of: a hyperlink that, when activated, navigates the Web-page pane; a terminal server client to a remote machine or application; a Unix shell client; an embedded browser; a local application; and an instance of a docked info bar.

17. The user interface of claim 15 wherein a user's interaction with Web content within the Web-page pane causes playback by an event engine of pre-recorded interaction with at least one application displayed in the embedded-application pane.

18. The user interface of claim 14 wherein the profile information specifies at least one URL identifying at least one remote server computer that hosts the at least one application.

19. The user interface of claim 14 wherein the at least one remote server is at least one of a Web server, a Windows application server, and a Unix application server.

20. A method of providing a distance-learning system, the method comprising:
dynamically constructing a toolbar's menu structure based on profile information retrieved from at least one menu profile server computer, wherein the menu structure includes at least one menu item that, when activated, launches at least one embedded application that is hosted on at least one remote server computer; and
displaying a client portion of the at least one embedded application within an embedded-application pane on a display of a user's computer.

21. The method of claim 20 wherein the profile information is specific to at least one of an institution and an individual.

22. The method of claim 20 wherein the profile information specifies at least one URL identifying the at least one remote server computer.

23. The method of claim 22 wherein the at least one remote server is at least one of a Web server, a Window application server, and a Unix application server.

24. The method of claim 20 wherein the at least one menu item is selected from the group consisting of: a terminal server client to a remote machine or application; a Unix shell client; an embedded browser; a local application; and an instance of a docked info bar.

25. The method of claim 20 wherein the toolbar and the embedded-application pane are displayed within a Web browser's display.

26. The method of claim 25 wherein the toolbar is displayed docked within the Web browser's display area.

27. The method of claim 25 wherein the at least one menu item is selected from the group consisting of: a hyperlink that, when activated, navigates a Web-page pane of the Web browser's display; a terminal server client to a remote machine or application; a Unix shell client; an embedded browser; a local application; and an instance of a docked info bar.

28. The method of claim 25 wherein a user's interaction with Web content within a Web-page pane of the browser's display causes playback by an event engine of pre-recorded interaction with at least one application displayed in the embedded-application pane.

29. The method of claim 20 wherein the at least one embedded application is an ActiveX COM object embedded within the toolbar.

30. The method of claim 29 wherein the toolbar is an ActiveX COM object embedded within a browser displayed on the user's computer.

31. The method of claim 20 wherein the toolbar and the embedded-application pane are displayed within a user's desktop.

32. The method of claim 20 wherein the toolbar and the embedded-application pane are displayed within a display area of a Windows application running on the user's computer.
